(19) United States
(12) Patent Application Publication
(10) Pub. No.: US 2018/0253712 A1
(43) Pub. Date: Sep. 6, 2018

(54) PRINTING APPARATUS, CONTROL METHOD OF PRINTING APPARATUS, AND PRINTING SYSTEM

(71) Applicant: SEIKO EPSON CORPORATION, Tokyo (JP)

(72) Inventors: Keigo MORI, Matsumoto (JP); Yoshinori OSHIMA, Matsumoto (JP); Koji HASHIMOTO, Matsumoto (JP); Dai TANAKA, Matsumoto (JP)

(21) Appl. No.: 15/910,866

(22) Filed: Mar. 2, 2018

(30) Foreign Application Priority Data
Mar. 3, 2017 (JP) 2017-040153

(51) Int. Cl. G06Q 20/20

(52) U.S. Cl. CPC G06Q 20/209; G06Q 20/202

(57) ABSTRACT

A printer includes a printing mechanism configured to print a paper receipt; a first communicator configured to communicate with a POS terminal; a second communicator configured to communicate with a management server; an electronic receipt information generator configured to, when receiving an electronic receipt issuing command and settlement information via the first communicator, generate electronic receipt information including address information to transmit the electronic receipt information from the second communicator; and a print processor configured to cause the printer to print the paper receipt based on the settlement information when the electronic receipt issuing command includes print instruction information that the paper receipt is to be printed.

This application claims priority under 35 U.S.C. § 119 to Japanese Patent Application No. 2017-40153 filed on Mar. 3, 2017, the entire disclosure of which is expressly incorporated by reference herein.

### BACKGROUND

### 1. Technical Field

The present invention relates to a printing apparatus configured to issue a paper receipt and generate an electronic receipt, and to a control method of the printing apparatus. The invention also relates to a printing system including the printing apparatus, a POS terminal, and a server.

### 2. Related Art

JP-A-2016-224652 and JP-A-2015-114687 describe a POS system which enables an electronic receipt to be issued when a settlement process is performed by a POS terminal in a retail establishment. The electronic receipt is electronic data obtained by digitizing settlement information generated by the settlement process. In the POS system described in JP-A-2016-224652, the settlement information is transmitted from the POS terminal to a server, where the electronic receipt is generated. A user who initiates settlement accesses the server by using an information terminal to obtain the electronic receipt. In the POS system described in JP-A-2016-224652, the settlement information is transmitted from the POS terminal to a printing apparatus. The electronic receipt is generated by the printing apparatus and then transmitted to the server. A user who initiates the settlement accesses the server by using an information terminal or the like to obtain the electronic receipt. In the POS system described in JP-A-2015-114687, it is possible to select issuance of a paper receipt, which is a paper sheet receipt on which the settlement information is printed, or issuance of an electronic receipt.

JP-A-2016-224652 fails to disclose that the printing apparatus generates an electronic receipt. In the POS system of JP-A-2015-114687, an operator, for example, a retail establishment clerk has to necessarily manipulate the printing apparatus to select an output form of the settlement information, that is, to select issuance of a paper receipt of the settlement information or issuance of an electronic receipt of the settlement information. Thus, the issuance of the paper receipt or generation of the electronic receipt may not be smoothly performed due to a manipulation error by an operator or a time taken to perform the manipulation.

### SUMMARY

An advantage of some aspects of the invention is that a printing apparatus which enables smooth issuance of a paper receipt and smooth generation of an electronic receipt and a control method of the printing apparatus are proposed. Another advantage of some aspects of the invention is that a printing system which enables smooth issuance of a paper receipt and smooth issuance of an electronic receipt is proposed.

A printing apparatus according to a first aspect of the invention includes: a printing mechanism configured to print a paper receipt; a first communicator configured to communicate with a POS terminal; a second communicator configured to communicate with a server; and a processor configured to, when receiving a first command including address information and settlement information from the POS terminal via the first communicator, generate electronic receipt information based on the first command and the settlement information to transmit the electronic receipt information including the address information to the server via the second communicator and to cause the printing mechanism to print the paper receipt based on the settlement information when the first command includes print instruction information that the paper receipt is to be printed.

According to the first aspect of the invention, transmitting the first command and the settlement information for causing issuance of the electronic receipt information from the POS terminal to the printing apparatus enables generation of the electronic receipt information. Moreover, whether or not a paper receipt is to be issued is determined based on whether or not the first command includes the print instruction information. Thus, manipulation of the printing apparatus by an operator is no longer required, which enables smooth issuance of the paper receipt and/or smooth generation of the electronic receipt information.

In this case, when the paper receipt is to be printed by the printing mechanism based on the print instruction information, the processor preferably causes the printing mechanism to print the paper receipt inclusively of copy information denoting that the paper receipt is a copy of the electronic receipt based on the electronic receipt information.

With this configuration, a customer who initiates a settlement process can distinguish the electronic receipt as an original from the paper receipt as a copy of the electronic receipt. Thus, it is possible to manage which of the electronic receipt and the paper receipt including identical settlement information is the original.

In this case, when the processor receives the settlement information via the first communicator after receiving a second command via the first communicator from the POS terminal, the processor preferably causes the printing mechanism to print the paper receipt based on the settlement information. With this configuration, it is possible to smoothly issue only the paper receipt without generating the electronic receipt information by the second command.

A second aspect of the invention is a control method of a printing apparatus configured to communicate with a POS terminal and a server, the method including: causing the printing apparatus to generate, when the printing apparatus receives a first command including address information and settlement information from the POS terminal, electronic receipt information based on the first command and the settlement information to transmit the electronic receipt information including the address information to the server, and causing the printing apparatus to print a paper receipt based on the settlement information when the first command includes print instruction information that the paper receipt is to be printed.

According to the control method of the printing apparatus of the second aspect of the invention, transmitting the first command and the settlement information for causing issuance of the electronic receipt information from the POS terminal to the printing apparatus enables generation of the electronic receipt information. Moreover, when the first command includes the print instruction information, it is possible to select the issuance of the paper receipt. Thus, manipulation of the printing apparatus by an operator is no longer required, which enables smooth issuance of the paper receipt and/or smooth generation of the electronic receipt information.

A third aspect of the invention is a printing system including a printing apparatus, a POS terminal configured to communicate with the printing apparatus, and a server configured to communicate with the printing apparatus, wherein the POS terminal is configured to transmit a first command including address information to the printing apparatus, the printing apparatus includes a printing mechanism configured to print a paper receipt and a processor configured to, when receiving a first command and settlement information from the POS terminal, generate electronic receipt information based on the first command and the settlement information to transmit the electronic receipt information including the address information to the server and to cause the printing mechanism to print the paper receipt based on the settlement information when the first command includes print instruction information that the paper receipt is to be printed, and when the server receives the electronic receipt information, the server transmits the electronic receipt information to the POS terminal based on the address information included in the electronic receipt information.

According to the printing system of the third aspect of the invention, transmitting the first command and the settlement information for causing issuance of the electronic receipt information from the POS terminal to the printing apparatus enables generation of the electronic receipt information. Moreover, when the first command includes the print instruction information, it is possible to select the issuance of the paper receipt. Thus, manipulation of the printing apparatus by an operator is no longer required, which enables smooth issuance of the paper receipt and/or smooth generation of the electronic receipt information. The electronic receipt information transmitted from the printing apparatus to the server is transmitted based on the address information included in the first command. Thus, a customer who initiates settlement by using an information terminal can obtain the electronic receipt based on the address information.

The printing system of the third aspect of the invention preferably further includes an information terminal configured to communicate with the POS terminal and the server, wherein the POS terminal is preferably configured to obtain the address information from the information terminal to generate the first command including the address information and to transmit the first command to the printing apparatus. With this configuration, it is possible to send the electronic receipt to the address stored in the information terminal.

In this case, the POS terminal may include a wireless communicator configured to acquire the address information from an information terminal of a customer by near-field wireless communication. With this configuration, it is possible to send the electronic receipt to the address stored in the information terminal.

In this case, the address information is preferably an email address, and the server is preferably an email server. With this configuration, it is possible to send the electronic receipt to the email address stored in the information terminal of the customer.

### BRIEF DESCRIPTION OF THE DRAWINGS

The invention will be described with reference to the accompanying drawings, wherein like numbers reference like elements.

FIG. 1 is a view schematically illustrating the system configuration of a POS system.

FIG. 2 is a block diagram illustrating a control system of the POS system.

FIG. 3 is a view illustrating commands transmitted from the POS terminal to a printer.

FIG. 4 is a flowchart of issuance operation of an electronic receipt.

FIG. 5 is a view illustrating an electronic receipt and a paper receipt.

### DESCRIPTION OF EXEMPLARY EMBODIMENTS

With reference to the drawings, embodiments of a printing apparatus and a printing system which embody aspects of the invention will be described below.

### POS System

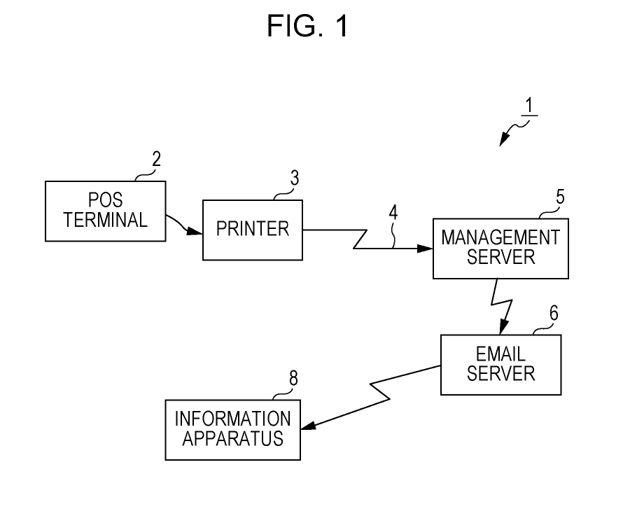

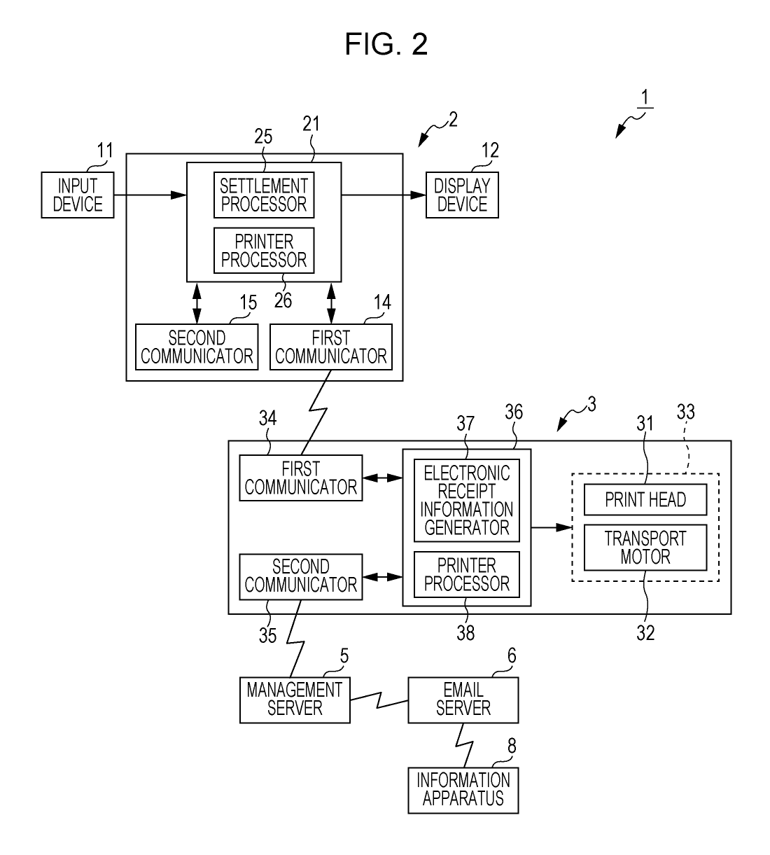

FIG. 1 is a view schematically illustrating the system configuration of a POS system. FIG. 2 is a block diagram illustrating a control system of the POS system. A POS system 1 (printing system) is located in a retail establishment and is used to perform a settlement process of, for example, products purchased by a customer and to issue a paper receipt and/or an electronic receipt. As illustrated in FIG. 1, the POS system 1 includes a POS terminal 2, a printer 3 (printing apparatus) connected to the POS terminal 2 so as to communicate with the POS terminal 2, a management server 5 connected to the printer 3 over a network 4 so as to communicate with the printer 3, and an email server 6 connected to the management server 5 so as to communicate with the management server 5. The POS terminal 2 and the printer 3 are located at a check-out counter of the retail establishment.

The POS terminal 2 calculates the billed amount of the products purchased by the customer and calculates, for example, the change for the deposit in the case of cash payment or performs a settlement process such as electronic money transfer in the case of performing the settlement by a method other than cash, for example, by a credit/debit card or by an electronic bill payment system so as to generate settlement information. Moreover, the POS terminal 2 transmits the settlement information including a command (first command) to the printer 3. The printer 3 prints the settlement information on a paper sheet receipt to issue a paper receipt based on the command from the POS terminal 2. Moreover, the printer 3 generates electronic receipt information obtained by digitizing the settlement information based on the command from the POS terminal 2. Moreover, when the printer 3 generates the electronic receipt information, the printer 3 acquires an email address included in the command from the POS terminal 2 to transmit the electronic receipt information including the email address to the management server 5. The email address is an email address stored in an information apparatus 8 of the customer. The management server 5 receives the electronic receipt information and then transmits the electronic receipt information to the email server 6. The management server 5 causes the email server 6 to transmit an electronic receipt including the electronic receipt information to the email address (address information) stored in the information apparatus 8 of the customer.

### POS Terminal

As illustrated in FIG. 2, the POS terminal 2 includes an input device 11 such as a keyboard or a bar-code reader for inputting a code number or a price of a product and a display device 12 such as a display for displaying the settlement information. The POS terminal 2 further includes a first communicator 14 (transmitter and receiver, communication circuit or communication board) configured to communicate with the printer 3 and a second communicator 15 (wireless communicator) (transmitter and receiver, communication circuit or communication board) configured to perform near-field wireless communication. The first communicator 14 includes universal serial bus (USB) as a communication interface, and the POS terminal 2 and the printer 3 are connected to each other via by a USB cable. The second communicator 15 is configured to communicate with the information apparatus 8 such as a mobile terminal of the customer based on a communication standard such as Bluetooth (registered trademark), IEEE802.11, Infrared Data Association (IrDA), Near Field Communication (NFC), or the like. The second communicator 15 acquires from the information apparatus 8 of the customer an email address stored in the information apparatus 8 by wireless communication.

The control system of the POS terminal 2 includes a terminal processor 21 (processor) as a main component. The terminal processor 21 includes a CPU (processor), ROM (memory device), which is a nonvolatile memory element, and RAM (memory device), which is a volatile memory element. The CPU reads a program which is stored in the ROM and which relates to the settlement process, and the CPU executes the program to generate the settlement information and various commands. The terminal processor 21 communicates with the printer 3 via the first communicator 14. The terminal processor 21 also communicates with the information apparatus 8 of the customer via the second communicator 15. The terminal processor 21 has an input side to which the input device 11 is connected. The terminal processor 21 has an output side to which the display device 12 is connected. The terminal processor 21 includes a settlement processor 25 and a printer processor 26 (printing apparatus processor).

The settlement processor 25 performs the settlement process of the products purchased by the customer based on an input through the input device 11 to generate the settlement information. The printer processor 26 controls an output format of the settlement information. That is, the printer processor 26 generates a command for specifying the format of a receipt and transmits the settlement information together with the command to the printer 3, thereby providing an instruction to issue a paper receipt, which is a paper sheet receipt on which the settlement information is printed, or an instruction to issue an electronic receipt obtained by digitizing the settlement information.

When the settlement information is to be issued as the paper receipt, the printer processor 26 transmits the settlement information together with a print command which is an instruction to print the paper receipt. That is, when the print processor 26 does not receive an input requesting the electronic receipt but receives an input for issuing the paper receipt through the input device 11, the printer processor 26 transmits the settlement information together with the print command.

On the other hand, when the print processor 26 receives an input instructing issuance of the electronic receipt through the input device 11, the printer processor 26 generates an electronic receipt issuing command (first command). Then, the printer processor 26 transmits the electronic receipt issuing command, the settlement information, and an electronic receipt issuance terminating command (second command) to the printer 3.

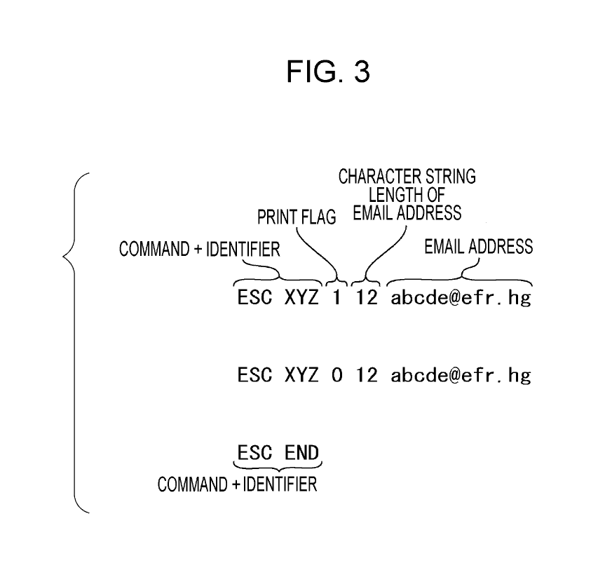

FIG. 3 is a view illustrating the electronic receipt issuing command and the electronic receipt issuance terminating command. In FIG. 3, the upper two commands are electronic receipt issuing commands, and the command shown under the two commands is the electronic receipt issuance terminating command. Each electronic receipt issuing command includes a command <ESC>, an identifier <XYZ> for identifying that the command is a command relating to electronic receipt issuance, a print flag (print instruction information) specifying whether or not the paper receipt is to be printed, an email address (address information) of the customer, and the character string length of the email address. When the paper receipt is to be issued along with generation and transmission of the electronic receipt information including the email address, the print flag is “1” as shown in the upper one of the electronic receipt issuing commands in FIG. 3. When only the electronic receipt is to be issued without issuing the paper receipt, the print flag is “0” as shown in the lower one of the electronic receipt issuing commands in FIG. 3. The email address is an address that the POS terminal 2 acquires from the information apparatus 8 of the customer through the second communicator 15. In this embodiment, the print flag is “1” when an instruction to issue the paper receipt is input through the input device 11, and the print flag is “0” when the lack of the need for the paper receipt is input through the input device 11. The electronic receipt issuance terminating command includes a command <ESC> and an identifier <END> for identifying that the command is a command for terminating the electronic receipt issuance.

### Printer

The printer 3 is a roll-paper printer configured to perform printing on a long paper sheet receipt fed from a roll paper holder. As illustrated in FIG. 2, the printer 3 includes a print head 31 and a transport motor 32 configured to transport a paper sheet receipt along a transport path passing a print location at which printing is performed by the print head 31. The print head 31 and the transport motor 32 form a printing mechanism 33 configured to print a paper receipt. The printer 3 further includes a first communicator 34 (transmitter and receiver, communication circuit or communication board) configured to communicate with the POS terminal 2 and a second communicator 35 (transmitter and receiver, communication circuit or communication board) configured to perform communication with a server over the network 4. The first communicator 34 includes a USB as a communication interface.

The control system of the printer 3 includes a processor 36 as a main component. The processor 36 includes, for example, a CPU (processor), ROM (memory device), which is a nonvolatile memory element, and RAM (memory device), which is a volatile memory element. The CPU reads a firmware program stored in the ROM and executes the program to control each component of the printer 3. The processor 36 communicates with the POS terminal 2 via the first communicator 34. The processor 36 also communicates with the management server 5 via the second communicator 35. The processor 36 has an output side to which the print head 31, the transport motor 32, a cutter, and the like are connected via a driver such as a transistor (not shown). The processor 36 includes an electronic receipt information generator 37 and a print processor 38.

When the electronic receipt information generator 37 receives the electronic receipt issuing command and the settlement information from the POS terminal 2 via the first communicator 34, the electronic receipt information generator 37 generates electronic receipt information. The email address included in the electronic receipt issuing command received from the POS terminal 2 is added to the electronic receipt information. In the present embodiment, the electronic receipt information is image data which enables display of the settlement information on a display or the like in the information apparatus 8, the management server 5, or the email server 6 in a manner equivalent to a case where the paper receipt is viewed.

Moreover, based on the character string length of the email address included in the electronic receipt issuing command, the electronic receipt information generator 37 extracts the email address included in the electronic receipt issuing command by identifying the email address as information corresponding to the character string length to acquire the email address as the information of the email address. Moreover, when the electronic receipt information generator 37 receives the electronic receipt issuance terminating command from the POS terminal 2 via the first communicator 34, the electronic receipt information generator 37 enter a state where the electronic receipt information generator 37 generates no electronic receipt information until the electronic receipt information generator 37 next receives the electronic receipt issuing command. Moreover, until the electronic receipt information generator 37 receives the electronic receipt issuance terminating command, the electronic receipt information generator 37 continues to generate and transmit the electronic receipt information each time the electronic receipt information generator 37 receives the settlement information based on the electronic receipt issuing command received for one time.

When the print flag of the electronic receipt issuing command is “1”, the print processor 38 issues the paper receipt along with generation and transmission of the electronic receipt information including the email address based on the settlement information transmitted together with the electronic receipt issuing command. That is, the print processor 38 drives the printing mechanism 33 (the print head 31 and the transport motor 32) based on the settlement information to print the settlement information on the paper sheet receipt passing through the print location and to cut the paper sheet receipt by the cutter so as to issue the paper receipt. In this embodiment, when the print flag of the electronic receipt issuing command is “1”, the print processor 38 prints the settlement information inclusively of copy information denoting that the paper receipt to be issued is a copy of the electronic receipt. In the present embodiment, the print processor 38 drives the printing mechanism 33 to generate a mark “COPY” meaning a copy, to print the mark on the paper sheet receipt, and then to print the settlement information on the paper sheet receipt. The mark “COPY” is stored in the ROM. The print processor 38 reads the mark and causes the printing mechanism 33 to print the mark.

In contrast, when the print flag of the electronic receipt issuing command is “0”, the print processor 38 does not issue the paper receipt.

Moreover, when the electronic receipt information generator 37 does not generate the electronic receipt, the print processor 38 issues the paper receipt. That is, when the print processor 38 receives the print command and the settlement information without receiving the electronic receipt issuing command or after receiving the electronic receipt issuance terminating command, the print processor 38 drives the printing mechanism 33 based on the print command and the settlement information to print the settlement information on the paper sheet receipt. Management Server and Email Server

When receiving the electronic receipt information including the email address from the printer 3, the management server 5 acquires the email address and the electronic receipt information. When the management server 5 acquires the email address, the management server 5 transmits the electronic receipt by designating the email address to the email server 6 managing the email address so as to cause the email server 6 to transmit the electronic receipt to the email address. In this embodiment, when, for example, the information apparatus 8 of the customer is a mobile phone, the email server 6 is an email server 6 of the communication carrier of the mobile phone. The management server 5 may be an email server configured to transmit to the email server 6 the electronic receipt transmitted from the printer.

### Issuance Operation of Electronic Receipt

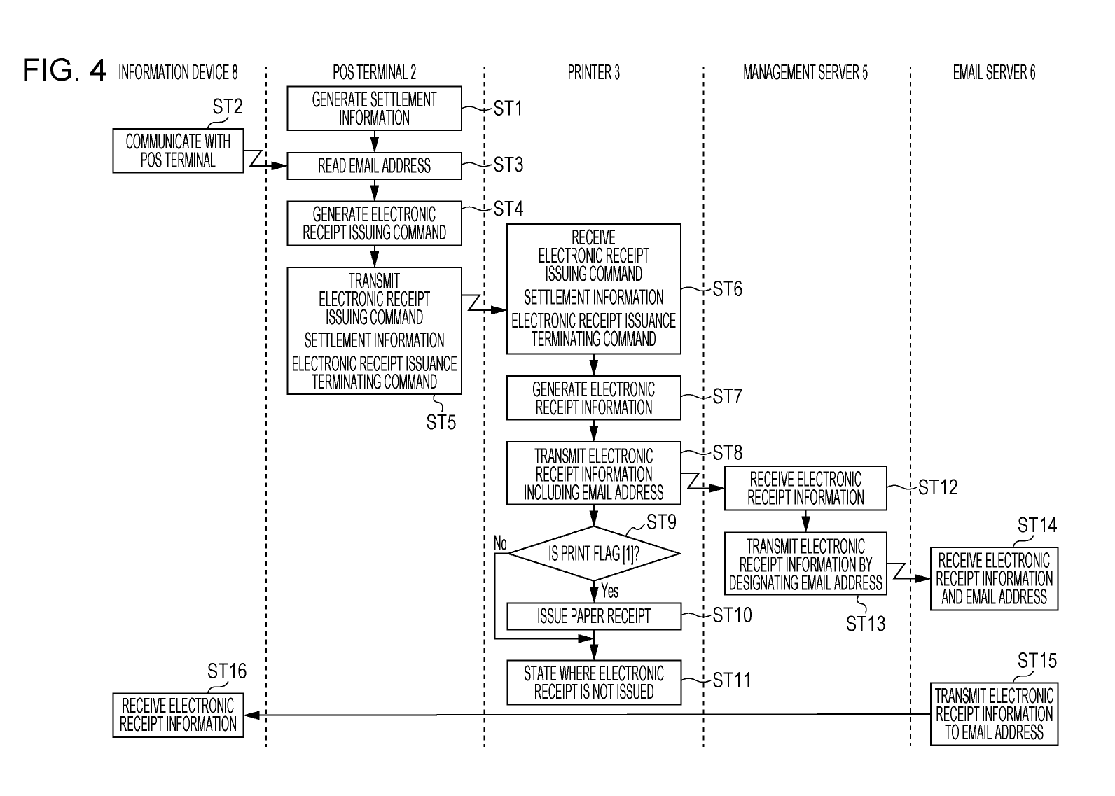

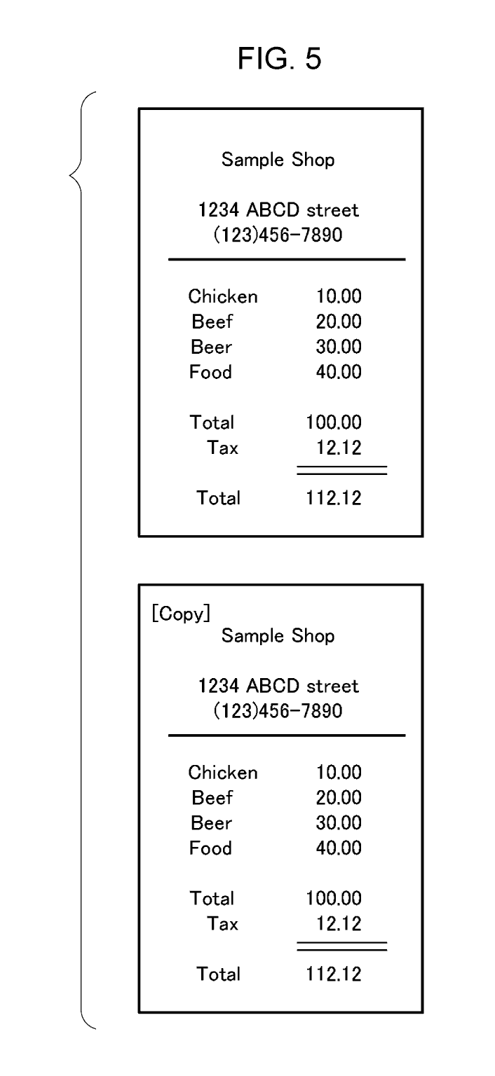

Next, with reference to FIGS. 4 and 5, issuance operation of an electronic receipt will be described. FIG. 4 is a flowchart of issuance operation of the electronic receipt. FIG. 5 is a view illustrating the electronic receipt and a paper receipt. It is assumed that a customer who initiates settlement of a product at a check-out counter wishes transmittance of an electronic receipt to a mobile phone (information apparatus 8) of the customer and issuance of a paper receipt as a copy of the electronic receipt.

In this case, a retail establishment clerk first causes the POS terminal 2 to perform the settlement process of the product purchased by the customer. Thus, the POS terminal 2 generates settlement information (step ST1). Next, the retail establishment clerk prompts the customer to hold the information apparatus 8 (mobile phone) of the customer over the second communicator 15 of the POS terminal 2 so as to establish communication between the information apparatus 8 and the POS terminal 2 by near-field wireless (step ST2). In this way, the POS terminal 2 acquires the email address from the information apparatus 8 of the customer (step ST3).

Moreover, the retail establishment clerk selects and inputs issuance of the paper receipt, issuance of the electronic receipt, or issuance of both the paper receipt and the electronic receipt to the POS terminal 2 by manipulating the input device 11. The POS terminal 2 may acquire selection information by near-field communication, the selection information being issuance of the paper receipt, issuance of the electronic receipt, or issuance of both the paper receipt and the electronic receipt and being set in the information apparatus 8 of the customer. When the issuance of both the paper receipt and the electronic receipt is selected, or when the issuance of the electronic receipt is selected, the POS terminal 2 generates an electronic receipt issuing command including the email address acquired from the information apparatus 8 of the customer and the character string length of the email address (step ST4). Moreover, the POS terminal 2 transmits to the printer 3 the settlement information generated in the settlement process together with the electronic receipt issuing command. When the issuance of the paper receipt is also selected, the print flag of the electronic receipt issuing command is “1”. When the issuance of the paper receipt is not selected, the print flag of the electronic receipt issuing command is “0”. The electronic receipt issuing command includes the email address acquired by the POS terminal 2 and the character string length of the email address. Moreover, the POS terminal 2 transmits the electronic receipt issuance terminating command to the printer 3 and then transmits the settlement information (step ST5). Note that when only the paper receipt is selected, the POS terminal 2 does not transmit the electronic receipt issuance terminating command but transmits the settlement information together with the print command to the printer 3 so that the settlement information is issued only as the paper receipt by the printer 3.

The printer 3 which has acquired the electronic receipt issuing command and the settlement information generates electronic receipt information from the settlement information based on the electronic receipt issuing command (steps ST6 and ST7). The electronic receipt information generated in step ST7 is image data. The electronic receipt information is, for example, image data of the image shown in the upper part in FIG. 5. The electronic receipt information is image data in a format which can be displayed on a display or the like in the information apparatus 8, the management server 5, or the email server 6 in a manner equivalent to a case where the paper receipt is viewed. The drawing shown in the lower part in FIG. 5 shows the paper receipt, and the image data of the electronic receipt information shown in the upper part in FIG. 5 has substantially the same legibility as the paper receipt.

Moreover, the printer 3 generates electronic receipt information including the email address and transmits the electronic receipt information to the management server 5 (step ST8). Moreover, when the print flag of the electronic receipt issuing command is “1” (step ST9: Yes), the printer 3 prints the settlement information on the paper sheet receipt. That is, the printer 3 issues the paper receipt. Here, when performing printing, the printer 3 prints the mark “COPY” on the paper sheet receipt to indicate that the paper receipt is a copy of the electronic receipt, and then, the printer 3 prints the settlement information (step ST10). The paper receipt printed in step ST10 is shown in the lower part in FIG. 5. When the POS terminal is to terminate an instruction of issuance of the electronic receipt, the POS terminal transmits the electronic receipt issuance terminating command to the printer 3. The printer 3 transitions to a state where the printer 3 does not issue the electronic receipt based on the electronic receipt issuance terminating command received from the POS terminal 2 (step ST11). Until the printer 3 receives the electronic receipt issuance terminating command from the POS terminal 2, the printer 3 continues to generate and transmit the electronic receipt information including the acquired email address each time the printer 3 receives the settlement information based on the electronic receipt issuing command received for one time.

Here, when the management server 5 acquires the electronic receipt information (step ST12), the management server 5 transmits the electronic receipt information to the email server 6 by designating the email address included in the electronic receipt information (step ST13). The email server 6 which has received the electronic receipt information and the email address from the management server 5 (step ST14) transmits the electronic receipt information to the email address (step ST15). In this way, the customer receives the electronic receipt information by the information apparatus 8 storing the email address (step ST16). The customer can view the electronic receipt information as the electronic receipt by activating a prescribed program by the information apparatus 8 and displaying the electronic receipt information on the display. Moreover, when the print flag of the electronic receipt issuing command is “1”, the printer 3 issues the paper receipt, and therefore, the customer obtains both the electronic receipt and the paper receipt.

In contrast, when the customer requires no paper receipt, the retail establishment clerk inputs an instruction of issuance of only the electronic receipt to the POS terminal 2 by manipulating the input device 11 after the settlement process is finished. Alternatively, the POS terminal 2 acquires selection information by near-field communication, the selection information being issuance of only the electronic receipt and being set in the information apparatus 8 of the customer. Thus, the POS terminal 2 transmits to the printer 3 the settlement information generated in the settlement process together with the electronic receipt issuing command. Thereafter, the POS terminal 2 transmits the electronic receipt issuance terminating command to the printer 3 (steps ST1 to ST5). In this case, the print flag of the electronic receipt issuing command generated in step ST4 is “0”.

In this case, the printer 3 which has acquired the electronic receipt issuing command and the settlement information generates electronic receipt information from the settlement information. Moreover, the printer 3 transmits the electronic receipt information including the email address to the management server 5. Thus, the electronic receipt information is transmitted to the information apparatus 8 (mobile phone) of the customer, the information apparatus 8 storing the email address (steps ST6 to ST8). However, since the print flag of the electronic receipt issuing command is “0” (step ST9: No), the printer 3 does not issue the paper receipt. Note that when the printer 3 receives the electronic receipt issuance terminating command from the POS terminal 2 after transmitting the electronic receipt, the printer 3 transitions to a state where the printer 3 does not issue the electronic receipt (step ST11).

Here, when the management server 5 acquires the electronic receipt information (step ST12), the management server 5 transmits the electronic receipt information to the email server 6 by designating the email address included in the electronic receipt information (step ST13). The email server 6 which has received the electronic receipt information and the email address from the management server 5 (step ST14) transmits the electronic receipt information to the email address (step ST15). In this way, the customer receives the electronic receipt information by the information apparatus 8 storing the email address (step ST16). The customer obtains the electronic receipt by the information apparatus 8.

Alternatively, when a customer who initiates settlement of a product at the check-out counter does not wish issuance of an electronic receipt, a retail establishment clerk inputs an instruction of issuance of only a paper receipt through the input device 11 of the POS terminal 2. Alternatively, the POS terminal 2 acquires selection information by near-field communication, the selection information being issuance of only the paper receipt and being set in the information apparatus 8 of the customer. Thus, the POS terminal 2 transmits to the printer 3 the settlement information generated in the settlement process together with the print command. In this embodiment, the printer 3 which has acquired the print command and the settlement information prints the settlement information on a paper sheet receipt to issue the paper receipt based on the print command. In this case, the print processor 38 prints the settlement information on the paper sheet receipt and does not issue the electronic receipt. Thus, the print processor 38 does not print the mark “COPY” meaning a copy on the paper sheet receipt.

### Operation and Advantages

According to the POS system 1 of the present embodiment, transmitting the electronic receipt issuing command and the settlement information from the POS terminal 2 to the printer 3 enables generation of the electronic receipt. Moreover, whether or not the paper receipt is to be issued is determined based on whether or not the electronic receipt issuing command includes the print instruction information. Thus, manipulation of the printer 3 by the retail establishment clerk is no longer required, which enables smooth issuance of the paper receipt and/or smooth generation of the electronic receipt.

Moreover, when the paper receipt is to be printed based on the print instruction information, the print processor 38 causes the printing mechanism 33 to print the paper receipt inclusively of copy information denoting that the paper receipt is a copy of the electronic receipt. Thus, a customer who initiates a settlement process can distinguish the electronic receipt as an original from the paper receipt as a copy of the electronic receipt. Thus, it is possible to manage which of the electronic receipt and the paper receipt including identical settlement information is the original.

Moreover, when the print processor 38 receives a termination command for terminating the generation of the electronic receipt information via the first communicator 34, the print processor 38 terminates the generation and transmission of the electronic receipt information. Then, when the print processor 38 receives the print command and the settlement information via the first communicator 34, the print processor 38 causes the printing mechanism 33 to print the paper receipt based on the settlement information. With this configuration, it is possible to smoothly issue only the paper receipt.

Moreover, in the present embodiment, the POS terminal 2 includes the second communicator 15 configured to acquire the email address from the information apparatus 8 of the customer by wireless communication. Thus, it is easy to send the electronic receipt information to the email address stored in the information apparatus 8.

Note that the management server 5 may be an email server configured to transmit to the email server 6 of a communication carrier the electronic receipt information transmitted from the printer 3. Thus, the electronic receipt information may be sent from the management server 5 to the email address stored in the information apparatus 8 of the customer.

### Other Embodiments

Note that the POS terminal 2 may include a database in which the ID and the email address of the customer are associated with each other, and when the POS terminal 2 receives the ID through the input device 11 or acquires the ID from the information apparatus 8 of the customer by near-field wireless communication, the POS terminal 2 may refer to the database so as to acquire the email address of the customer.

Moreover, the first communicator 14 of the POS terminal 2 and the first communicator 34 of the printer 3 may be configured to connect the POS terminal 2 and printer 3 to each other by Bluetooth (registered trade mark), IEEE802.11, IrDA, NFC, or the like such that wireless communication between the POS terminal 2 and the printer 3 is possible.

Note that in the above-described embodiment, the electronic receipt issuing command includes the email address, but the electronic receipt issuing command may include, instead of the email address, an address such as a URL denoting the address of a memory region of the management server 5, an IP address denoting the address of the memory apparatus on the network 4, or the like. In this case, the printer 3 transmits the electronic receipt to the address included in the electronic receipt issuing command.

Moreover, when the printer 3 receives the electronic receipt issuing command, the operation mode of the printer 3 may transition to an electronic receipt issuance mode in which an electronic receipt is always generated and transmitted to the management server 5.

In this case, when the printer 3 transitions to the electronic receipt issuance mode and then receives the settlement information, the printer 3 which has received the electronic receipt issuing command necessarily generates the electronic receipt information based on the received electronic receipt issuing command, and the printer 3 transmits the electronic receipt information to the management server 5. Thereafter, until the printer 3 receives an electronic receipt issuance termination mode command, the printer 3 maintains its operation mode as the electronic receipt issuance mode. Then, when the printer 3 receives the electronic receipt issuance termination mode command, the operation mode of the printer 3 transitions to a normal print mode in which no electronic receipt is issued. When the printer 3 transitions to the normal print mode and then receives the print command and the settlement information, the printer 3 issues only the paper receipt. Until the printer 3 next receives the electronic receipt issuing command, the printer 3 maintains the normal print mode for issuing only the paper receipt.

Note that the above-described embodiment is merely to show an aspect of the invention, and arbitrary modifications and applications within the scope of the invention are possible.

Moreover, for example, when the above-described control method of the printer 3 (the control method of the printing apparatus) is realized by a computer included in the printer 3, the invention may be configured in a form of a program which is executed by the computer to realize the control method, a recording medium recording the program in a computer-readable manner, or a transmission medium for transmitting the program. As the recording medium, a magnetic or optical recording medium or a semiconductor memory device may be used. Specifically, examples of the recording medium include a portable or stationary recording medium such as a flexible disk, hard disk drive (HDD), compact disk read only memory (CD-ROM), digital versatile disk (DVD), Blu-ray (registered trade mark) Disc, magneto-optical disk, flash memory, and card-type recording medium. Moreover, the recording medium may be a nonvolatile memory apparatus such as random access memory (RAM), read only memory (ROM), or HDD which is an internal memory apparatus included in the printer 2.

Moreover, the functional components shown in FIG. 1 indicate functional configurations, and the specific packing form of the components is not particularly limited. That is, it is not necessarily required to pack hardware components corresponding individually to the functional components, but one processor may execute a program to realize functions of the plurality of functional components. Moreover, some of the functions realized by software in the above-described embodiment may be realized by hardware, or some of the functions realized by hardware may be realized by software. Moreover, the specific detailed configurations of components of the printer 3 and the POS terminal 2 may arbitrarily be modified without departing from the scope of the invention.

What is claimed is:

1. A printing apparatus comprising:
a printing mechanism configured to print a paper receipt;
a first communicator configured to communicate with a POS terminal;
a second communicator configured to communicate with a server; and
a processor configured
to, when receiving a first command including address information and settlement information from the POS terminal via the first communicator, generate electronic receipt information based on the first command and the settlement information to transmit the electronic receipt information including the address information to the server via the second communicator and
to cause the printing mechanism to print the paper receipt based on the settlement information when the first command includes print instruction information that the paper receipt is to be printed.

2. The printing apparatus according to claim 1, wherein
when the paper receipt is to be printed by the printing mechanism based on the print instruction information, the processor causes the printing mechanism to print the paper receipt inclusively of copy information denoting that the paper receipt is a copy of the electronic receipt based on the electronic receipt information.

3. The printing apparatus according to claim 1, wherein
when the processor receives the settlement information via the first communicator after receiving a second command via the first communicator from the POS terminal, the processor causes the printing mechanism to print the paper receipt based on the second command and the settlement information.

4. A control method of the printing apparatus configured to communicate with a POS terminal and a server, the control method comprising:
causing the printing apparatus to generate, when the printing apparatus receives a first command including address information and settlement information from the POS terminal, electronic receipt information based on the first command and the settlement information to transmit the electronic receipt information including the address information to the server, and
causing the printing apparatus to print a paper receipt based on the settlement information when the first command includes print instruction information that the paper receipt is to be printed.

5. The control method according to claim 4, wherein
when the paper receipt is to be printed based on the print instruction information, the printing apparatus is caused to print the paper receipt inclusively of copy information denoting that the paper receipt is a copy of the electronic receipt based on the electronic receipt information.

6. The control method according to claim 4, wherein
when the printing apparatus receives the settlement information after receiving a second command from the POS terminal, the paper receipt is printed based on the settlement information.

7. A printing system comprising:
a printing apparatus, a POS terminal configured to communicate with the printing apparatus, and a server configured to communicate with the printing apparatus, wherein
the POS terminal is configured to transmit a first command including address information to the printing apparatus,
the printing apparatus includes
a printing mechanism configured to print a paper receipt and
a processor configured
to, when receiving a first command and settlement information from the POS terminal, generate electronic receipt information based on the first command and the settlement information to transmit the electronic receipt information including the address information to the server and
to cause the printing mechanism to print the paper receipt based on the settlement information when the first command includes print instruction information that the paper receipt is to be printed, and
when the server receives the electronic receipt information, the server transmits the electronic receipt information to the POS terminal based on the address information included in the electronic receipt information.

8. The printing system according to claim 7, further comprising
an information terminal configured to communicate with the POS terminal and the server, wherein
the POS terminal is configured to obtain the address information from the information terminal to generate the first command including the address information and to transmit the first command to the printing apparatus.

9. The printing system according to claim 8, wherein
the POS terminal includes a wireless communicator configured to acquire the address information from an information terminal by near-field wireless communication.

10. The printing system according to claim 8, wherein
the address information is an email address, and
the server is an email server.

11. The printing system according to claim 8, wherein
when the paper receipt is to be printed by the printing mechanism based on the print instruction information, the processor causes the printing mechanism to print the paper receipt inclusively of copy information denoting that the paper receipt is a copy of the electronic receipt based on the electronic receipt information.

12. The printing system according to claim 8, wherein
when the processor of the printing apparatus receives the settlement information via the first communicator after receiving a second command via the first communicator from the POS terminal, the processor causes the printing mechanism to print the paper receipt based on the second command and the settlement information.
